(19) United States
(12) Patent Application Publication
(10) Pub. No.: US 2017/0083147 A1
(43) Pub. Date: Mar. 23, 2017

(54) DISPLAY DEVICE AND ELECTRONIC DEVICE WITH PRESSURE SENSING

(71) Applicant: HannStar Display Corporation, Taipei City (TW)

(72) Inventors: Chen-Hao SU, Taichung City (TW); Yu-Ting CHEN, Taoyuan City (TW)

(21) Appl. No.: 15/270,006

(22) Filed: Sep. 20, 2016

(30) Foreign Application Priority Data
Sep. 22, 2015 (TW) 104131297

(51) Int. Cl. G06F 3/041; G02F 1/1335; G06F 3/044

(52) U.S. Cl. CPC G06F 3/0416; G06F 3/0412; G06F 3/0414; G06F 3/044; G02F 1/133602; G06F 2203/04105; G06F 2203/04111

(57) ABSTRACT

The display device includes a display panel, a back light module, a first sensing electrode and a second sensing electrode. The back light module has a first side and a second side which are opposite to each other. The display panel is disposed at the first side of the back fight module. The first sensing electrode is disposed at the first side of the back light module, and at least part of the second sensing electrode is disposed at the second side of the back light module, and the second sensing electrode is separated from the first sensing electrode by a predetermined distance. Accordingly the display device has functions of pressure sensing.

### RELATED APPLICATIONS

This application claims priority to Taiwan Application Serial Number 104131297 filed Sep. 22, 2015, which is herein incorporated by reference

### BACKGROUND

Field of Invention

The present invention relates to a display device. More particularly, the present invention relates to the display device with pressure sensing and touch sensing.

Description of Related Art

In recent years, technology advances, touch screen has become increasingly widespread, from the common Automated Teller Machine (ATM), smartphone and tablet to industrial touch computers, etc. Users can select a picture, input text and draw pictures by touching the touch screen, and hence an intuitive human-machine interface is formed. In general, the touch screen can only detect whether the user touch the screen. However, pressure sensors are disposed on some devices for detecting the force of the touch caused by the user, and a variety of user operations are devised accordingly. Therefore, how to implement the pressure sensors in the touch screen is an issue concerned by people in the art.

### SUMMARY

To solve the above problems, embodiments of the present invention provide a display device with pressure sensing. The display device includes a display panel, a back light module, a first sensing electrode and a second sensing electrode. The display panel includes a first substrate and a second substrate. The back light module has a first side and a second side which are opposite to each other. The display panel is disposed at the first side of the back tight module. The first sensing electrode is disposed at the first side of the back light module. At least part of the second sensing electrode is disposed at the second side of the back light module and is separated from the first sensing electrode by a predetermined distance.

In same embodiments, the second sensing electrode is a battery or a frame.

In some embodiments, the display device further includes a touch module. The touch module includes a glass substrate, and the glass substrate has a first side and a second side which are opposite to each other. The display panel is disposed between the touch module and the back light module and disposed at the second side of the glass substrate. The display device has a display area and a non-display area. The first sensing electrode is disposed at the second side of the glass substrate and disposed in the non-display area.

In some embodiments, the first sensing electrode and the second sensing electrode are configured to detect a force along a normal vector of the display panel, and to output a pressure sensing signal.

In some embodiments, the second substrate has a first side and a second side which are opposite to each other. The first substrate is disposed at the first side of the second substrate the back light module is disposed at the second side of the second substrate, and the first sensing electrode is disposed at the second side of the second substrate.

In some embodiments, display device further includes a polarizer which is disposed between the second substrate and the first sensing electrode.

In some embodiments, display device further includes a touch module, and the touch module is an embedded touch module or an out-cell touch module.

In some embodiments, the display device has a display area and a non-display area, and the first sensing electrode is disposed in the display area.

In some embodiments, display device further includes a touch module. The touch module includes a touch sensing electrode. The first substrate has a first side and a second side which are opposite to each other. The touch sensing electrode is disposed at one of the first side and the second side of the first substrate.

In some embodiments, display device further includes a touch module. The touch module includes two touch sensing electrodes. The first substrate has a first side and a second side which are opposite to each other. The touch sensing electrodes are respectively disposed at the first side and the second side of the first substrate.

In some embodiments, the display device further includes a touch module. The touch module includes two touch sensing electrodes. The touch sensing electrodes are respectively disposed on the first substrate and on the second substrate.

In some embodiments, the touch module includes a black matrix, and the black matrix is disposed between the glass substrate and the first sensing electrode.

In some embodiments, the first sensing electrode is a patterned sensing electrode.

In some embodiments, the first sensing electrode is formed of one of indium tin oxide, metal mesh, and nano-meter metal wire.

In some embodiments, the second sensing electrode is a conductor.

Embodiments of the present invention provide an electronic includes the described display device.

### BRIEF DESCRIPTION OF THE DRAWINGS

The invention can be more fully understood by reading the following detailed description of the embodiment, with reference made to the accompanying drawings as follows:

FIG. 1A to FIG. 1E are diagrams acing the disposition of a display device according to some embodiments.

FIG. 2, FIG. 3 and FIG. 4 are cross-sectional diagrams of the display device based on some embodiments.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology, but are not referred to particular order or sequence. In addition, the term “couple” used in the specification should be understood for electrically connecting two units directly or indirectly. In other words, when “a first object is coupled to a second object” is written in the specification, it means another object may be disposed between the first object and the second object.

Embodiments of the present invention provide a display device. The display device at least includes a display panel and a back light module. The display panel includes a first substrate and a second substrate. The display panel is disposed at a first side of the back light module. In particular, the display device further includes a first sensing electrode and a second sensing electrode for sensing pressure. The first sensing electrode is disposed at the first side of the back light module, and at least part of the second sensing electrode is disposed at the second side of the back light module and is separated from the first sensing electrode by a predetermined distance. Accordingly, when the display device is pressed, the distance between the first sensing electrode and the second sensing electrode is changed, and hence the capacitance formed between the two sensing electrodes are changed correspondingly. Therefore, a pressure sensing signal is generated according to the variation of the capacitance. Several embodiments are provided below.

In some embodiments, the display device further includes a touch module which could be an out-cell touch module or an embedded touch module. The two types of the touch module are described in brief below.

The out-cell touch module may be, for example, glass-glass (GG) touch module, one glass solution (OGS) touch module, glass-film (GF) touch module or glass-film-film (GFF) touch module. With respect to the GG touch module, patterned sensing electrodes are disposed on sensor glass, and the sensor glass is bonded with a cover lens to form the touch module. With respect to the OGS touch module, the patterned sensing electrode is directly disposed on the cover lens so as to omit the sensor glass to achieve advantage of thinness. With respect to the GF touch module, the patterned sensing electrodes are disposed on a film substrate, and the film substrate is bonded to the cover lens to form the touch module, in which the patterned sensing electrodes may be all disposed on one surface of the film substrate, or disposed on both surfaces of the film substrate. With respect to the GFF film, the patterned sensing electrodes are disposed on two film substrates, and the two film substrates are boned to the cover lens to form the touch module. Note that the cover lens may be formed of the common toughened glass, and may be also formed of plastic or other material, which is not limited in the invention. In addition, the aforementioned sensor glass may also be replaced with plastic or other material, which is not limited in the invention either. The material of the film substrate may include polymer, composites or the combination thereof. For example, the material may include, but not limited to, polyethylene terephthalate (PET), polycarbonate (PC), polyether sulfone (PES), triacetyl cellulose (TAC), PMMA, polyethylene, COP, polyimide (PI), composites of PC and PMMA, etc.

The embedded touch module is implemented in the display panel such as In-Cell capacitive touch panel, On-Cell capacitive touch panel, and hybrid touch panel. With respect to the In-Cell capacitive touch panel, touch sensing electrodes are integrated into a thin film transistor (TFT) substrate. With respect to the On-Cell capacitive touch panel, the touch sensing electrodes are integrated into a color filter (CF) substrate. With respect to the hybrid capacitive touch panel, the touch sensing electrodes are disposed both on the TFT substrate and the CF substrate. For example, in one embodiment of the hybrid capacitive touch panel, a transmitter (TX) electrode is disposed on the TFT substrate, and a receiver (RX) electrode is disposed on the CF substrate. The embedded touch panel has advantages of thinness because an extra touch module is not required.

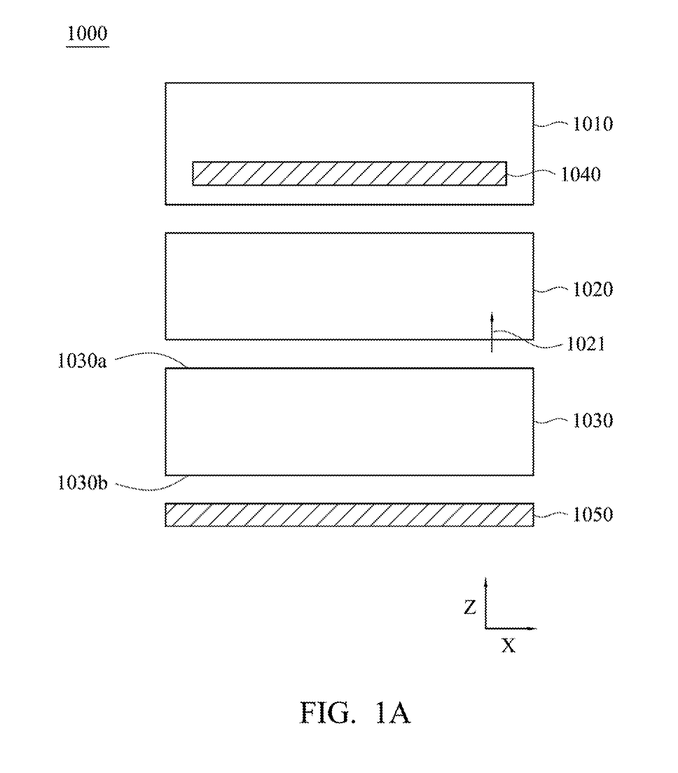

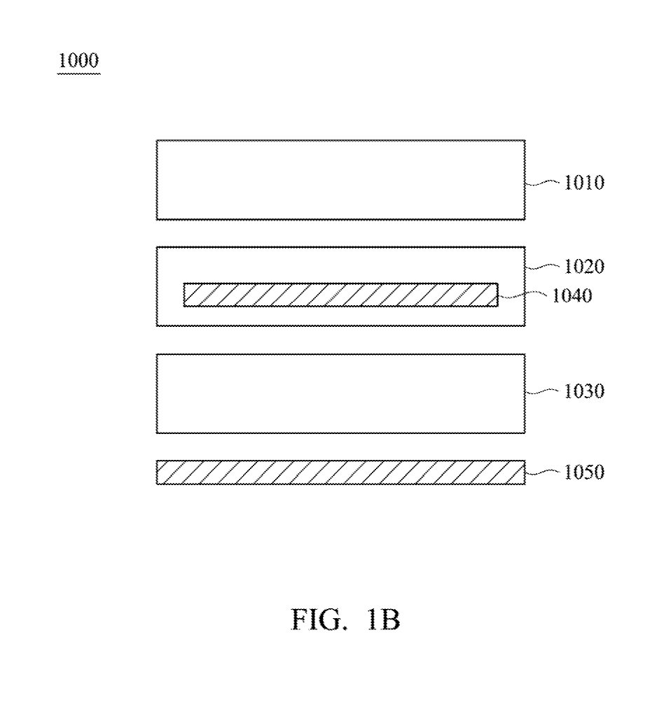

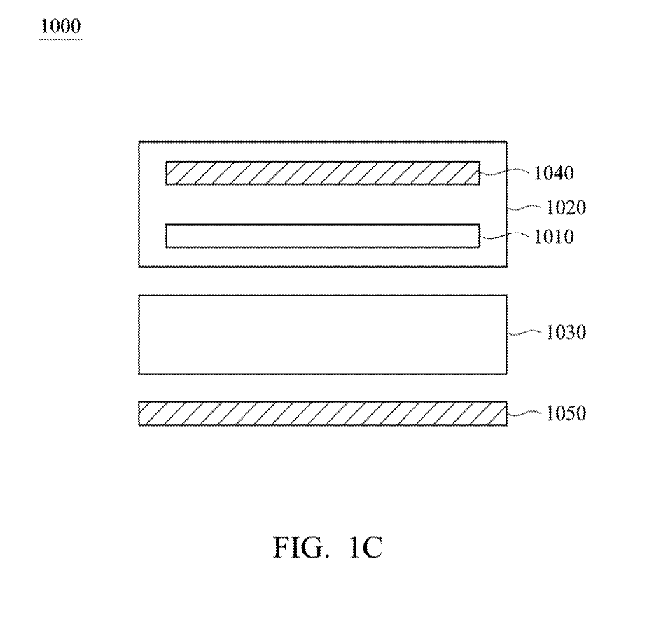

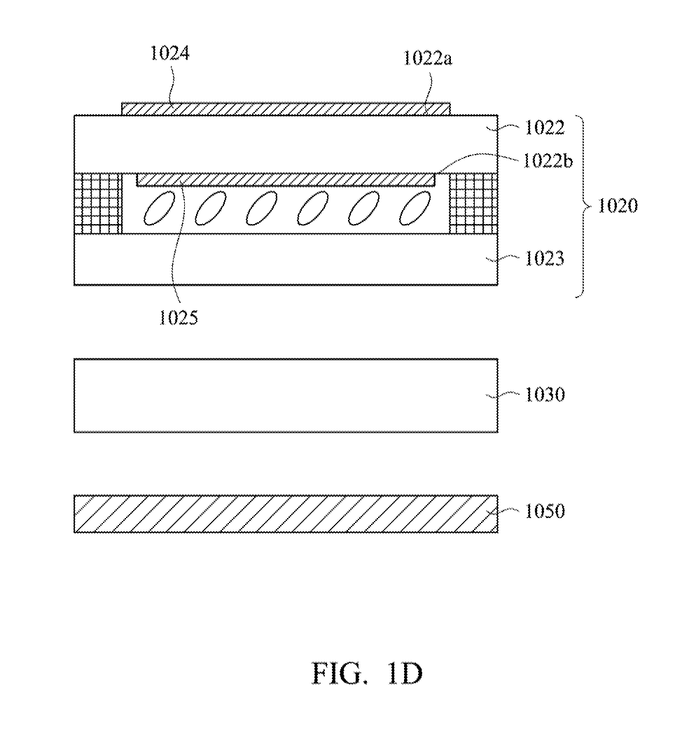

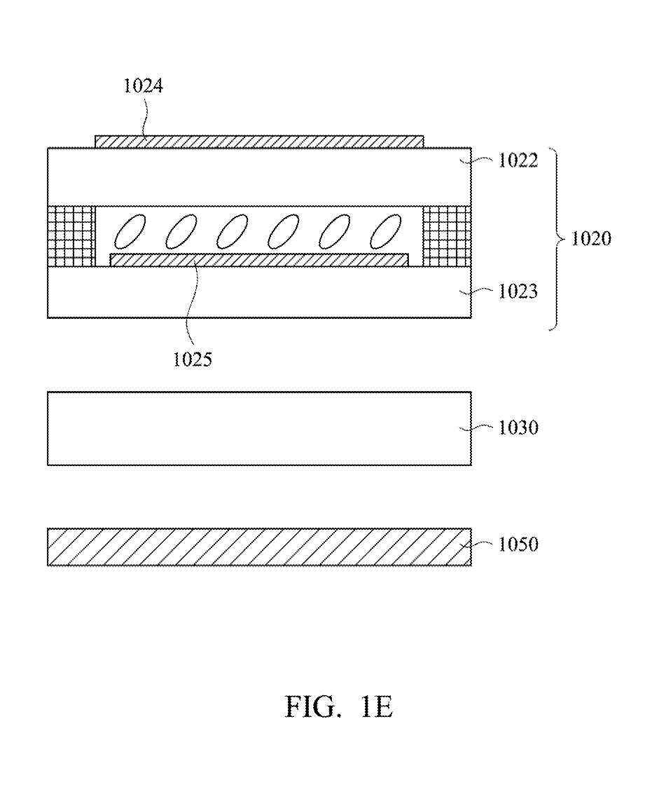

FIG. 1A to FIG. 1E are diagrams illustrating the disposition of the display device according to some embodiments. The out-cell touch module is applied in the embodiments of FIG. 1A and FIG. 1B. The embedded touch module is applied in the embodiments of FIG. 1C to FIG. 1E. Identical or similar units will not be repeatedly described and labeled.

Refer to FIG. 1A, the display device 1000 includes a touch module 1010, a display panel 1020, a back light module 1030, a first sensing electrode 1040 and a second sensing electrode 1050. The display device 1000 may be implemented as any type of screen such as the screens on smart phone, tablet, laptop or industrial computer, which is not limited in the invention. The embodiments of the touch module 1010 have been described above, and therefore they will not be repeated. The display panel 1020 may include substrates, polarizer, liquid crystal, alignment film, TFT, common electrode, etc., but the units in the display panel 1020 are not limited in the invention. The back light module 1030 is configured to provide light. For example, Light-Emitting Diode (LED) is used to provide the light, but the invention is not limited thereto. The back light module 1030 has a first side 1030a and a second side 1030b which are opposite to the each other. The touch module 1010 and the display panel 1020 are disposed at the first side 1030a.

In the embodiment of FIG. 1A, the first sensing electrode 1040 is disposed in the touch module 1010. For example, the first sensing electrode 1040 is an additionally disposed sensing electrode. Alternatively, the first sensing electrode 1040 may also be the sensing electrode used to detect touch, and configured to output a touch signal and a pressure sensing signal in a time-division way. In the embodiment, the material of the first sensing electrode 1040 includes indium tin oxide (ITO). However, in other embodiments, the material of the first sensing electrode 1040 may also include other conductive and transparent material such as nano-meter metal wire (e.g. nano-meter silver wire or nano-meter copper wire), patterned metal mesh which has width from 0.05 micron meter to 8 micron meter and light transmittance aperture higher than 85%.

The second sensing electrode 1050 may be any electrode which is capable of providing reference voltage or ground voltage in the display device 1000. For example, second sensing electrode 1050 may be a battery, a frame, an electrode on a film substrate, a circuit board or a conductor having a certain area. The frame may be a middle frame of a cell phone or a frame of the display panel 1020, and the material of the frame includes metal or other suitable conductors.

The first sensing electrode 1040 is at least partially overlapped with the second sensing electrode 1050 along a Z-axis. A capacitance is formed between first sensing electrode 1040 and the second sensing electrode 1050. When the display device 1000 is pressed (e.g. by hands on the cover lens or the display panel), the distance between the first sensing electrode 1040 and the second sensing electrode 1050 is changed at least in part of the overlapped area. It causes capacitance variation between the first sensing electrode 1040 and the second sensing electrode 1050. Based on the magnitude of the capacitance variation, the first sensing electrode 1040 and the second sensing electrode 1050 are configured to output a pressure sensing signal representing the magnitude of the external force. From another aspect, the display panel 1020 has a normal vector 1021 (i.e. parallel with the Z-axis and the first sensing electrode 1040 and the second sensing electrode 1050 are cooperated with a pressure sensing circuit (not shown) to detect the force along the normal vector 1021 of the display panel 1020 and to output the pressure sensing signal.

In the embodiment, the first sensing electrode 1040 may be patterned electrodes or a whole layer of electrode. The patterned electrodes are configured for addressing. In addition to determine the location (i.e. on Z-axis) along the normal vector 1021 which is perpendicular to the surface of the display panel 1020, the patterned electrodes may also be configured to determine the location (i.e. on X-axis and Y-axis) parallel to the surface of the display panel 1020. For example, the sensing electrode 1040 is patterned into 15 sub-electrodes such that when the function of the touch module 1010 is not activated or not enabled, the touch location on X-axis and Y-axis can also be detected, but in this case, the touch resolution is 15 locations rather than the original resolution of the touch module 1010.

In the embodiment of FIG. 1B, the first sensing electrode 1040 is disposed in the display panel 1020. The first sensing electrode 1040 could be any electrode in the display panel 1020. For example, the first sensing electrode 1040 may be a sensing electrode on a side of the back light module near to the TFT substrate, a common electrode at inner side of the CF substrate (near to liquid crystal) in the TN/VA mode of the display panel 1020, an electrode at outer side of the CF substrate (near to the touch module 1010) in the IPS mode of the display panel 1020 for preventing from electrostatic discharge (ESD), or a common electrode in a pixel structure on the TFT substrate.

Refer to FIG. 1C, when the embedded touch module is applied, the touch module 1010 is implemented in the display panel 1020. In the embodiment of FIG. 1C, the first sensing electrode 1040 is disposed in the display panel 1020. For example, the first sensing electrode 1040 may be a sensing electrode at a side of the back, light module 1030 near to the TFT substrate, a common electrode or an electrode for preventing from the ESD. With respect to the embedded touch module, several embodiments are further provided below,

Refer to FIG. 10, in the embodiment of FIG. 1D, the touch module is the On-Cell capacitive touch panel, in which the touch module has only one touch sensing electrode. To be specific, the display panel 1020 includes a first substrate 1022 and a second substrate 1023. The first substrate 1022 has a first side 1022a and a second side 1022b which are opposite to each other. The aforementioned touch sensing electrode is disposed at the first side 1022a of the first substrate 1022 (become the sensing electrode 1024), or at the second side 1022b of the first substrate 1022 (become the sensing electrode 1025). In other words, only one of the sensing electrode 1024 and 1025 is disposed in the display panel 1020. The aforementioned first sensing electrode 1040 then may be disposed at any suitable location in the display panel 1020. For example, the first sensing electrode 1040 may be a sensing electrode at a side of the back light module 1030 near to the second substrate 1023, a common electrode on the second substrate 1023. Alternatively, only one of the sensing electrode 1024 and 1025 is disposed in the display panel 1020, and the only sensing electrode is taken as the first sensing electrode 1040 to detect pressure cooperated with the sensing electrode 1050 in addition to detect touch in a time-division way.

In some embodiments, the touch module is the On-Cell capacitive touch panel but includes two sensing electrodes 1024 and 1025. The sensing electrodes 1024 and 1025 are used to detect touch. The aforementioned first sensing electrode 1040 may be disposed at any suitable location in the display panel 1020. For example, the first sensing electrode 1040 may be a sensing electrode at a side of the back light module 1030 near to the second substrate 1023, a common electrode on the second substrate 1023. Alternatively, one of the sensing electrode 1024 and 1025 is configured to detect touch, and is also taken as the first sensing electrode 1040 to detect pressure with the sensing electrode 1050 in a time-division way.

Refer to FIG. 1E, in the embodiment of FIG. 1E, the touch module is the hybrid capacitive touch panel. The touch module includes both of the sensing electrodes 1024 and 1025. The sensing electrode 1024 is disposed on the first substrate 1022, and the sensing electrode 1025 is disposed on the second substrate 1023. One of the sensing electrodes 1024 and 1025 is configured to detect touch, and is also configured to detect pressure with the sensing electrode 1050 in a time-division way. Alternatively, the first sensing electrode 1040 may be a sensing electrode at a side of the back light module 1030 near to the second substrate 1023, or common electrode on the second substrate 1023.

In the embodiments of FIG. 1A to FIG. 1E, the display device 1000 includes the touch module. However, the display device 1000 may not include the touch module in other embodiments. In other words, in that case, the display device 1000 does not have the touch function, and the sensing electrodes 1040 and 1050 outputting the pressure sensing signal could be patterned electrodes or a layer of electrode. That is to say, the function of sensing pressure will not be affected, no matter how the touch functions for X and Y directions are implemented, or whet her the touch functions for X and Y directions are provided in the display device 1000.

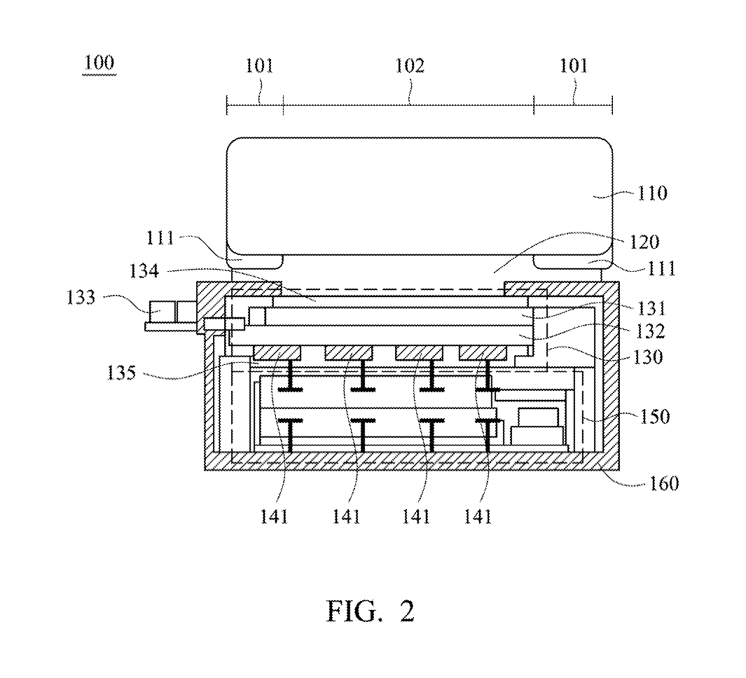

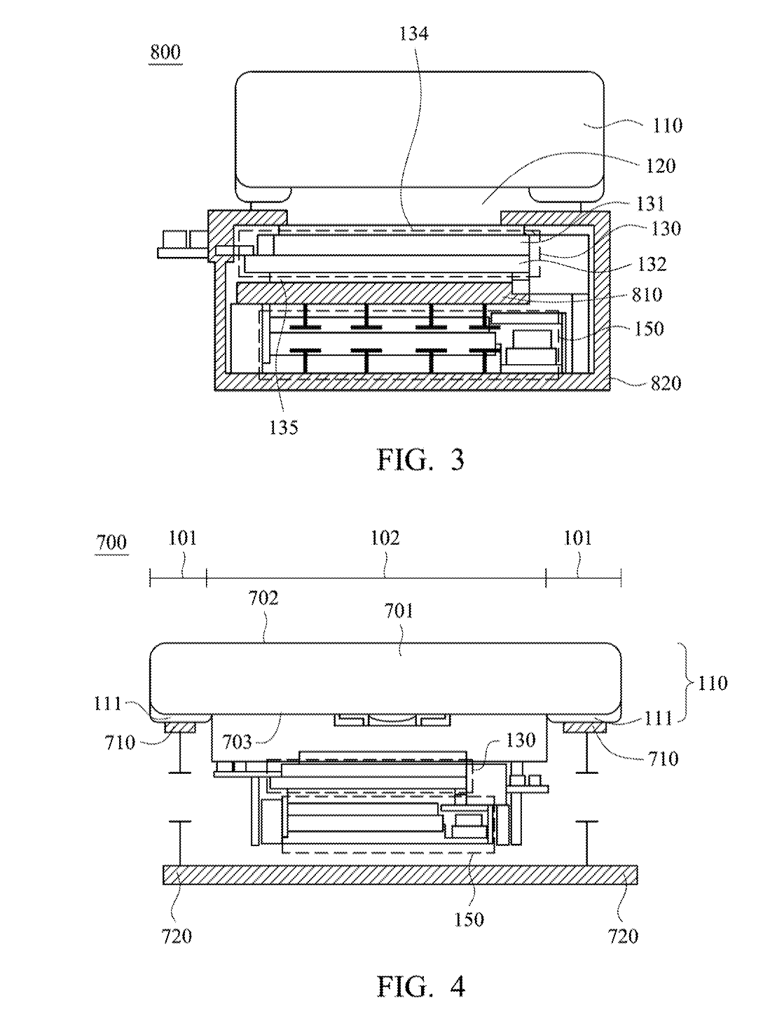

FIG. 2 is a cross-sectional view of the display device according to some embodiments. Refer to FIG. 2, a display device 100 includes a touch module 110, a display panel 130, and a back light module 150. The display device 100 may be implemented as any type of screen such as the screens on smart phone, tablet, laptop or industrial computer, which is not limited in the invention.

The touch module 110 may be any type of out-cell touch module. Each aspect of the out-cell touch module has described above, and it will not be repeated. The display panel 130 is disposed between the touch module 110 and the back light module 150. The display panel 130 includes a substrate 131 (also referred to a first substrate or the CF substrate), and a substrate 132 (also referred to a second substrate or the TFT substrate). The substrate 132 is disposed between the substrate 131 and the back light module 150. The substrate 131 and the substrate 132 may be formed of same or different material such as glass, polymer, composites, or the combination thereof, or they may be formed of the material of the aforementioned film substrate.

The touch module 110 and the display panel 130 are bonded by optical clear adhesive (OCA) 120. The display device 100 has a display area 102 and a non-display area 101. A black matrix 111 is disposed in the non-display area 101. The back light module 150 is configured to provide light. For example, LED is used to provide light, but the invention is not limited thereto. Except for the said units, the display device 100 further includes a driving circuit 133, polarizers 134 and 135. For clarity, not all of the units in the display device are illustrated in FIG. 2.

In particular, the display device 100 further includes a first sensing electrode 141 and a second sensing electrode 160. When different electric potentials are respectively applied to the first sensing electrode 141 and second sensing electrode 160, capacitance is formed between the two electrodes in the overlapped area. In detail, the substrate 132 has a first side and a second side which are opposite to each other, the substrate 131 is disposed at the first side, and the back light module 150 is disposed at the second side of the substrate 132. In the embodiment, the first sensing electrode 141 is disposed at the second side of the substrate 132 near to the back light module 150. In some embodiments, the material of the first sensing electrode 141 includes ITO, and the first sensing electrode 141 is directly in contact with the substrate 132. However, in other embodiments, the material of the first sensing electrode 141 may include other conductive and transparent material such as nano-meter metal wire (e.g. nano-meter silver wire or nano-meter copper wire), patterned metal mesh which has width from 0.05 micron meter to 8 micron meter and light transmittance aperture higher than 85%. In addition, the second sensing electrode 160 is separated from the substrate 132 by a predetermined distance. For example, the second sensing electrode 160 is disposed at a side of the display panel 130 far from the touch module 110. The second sensing electrode 160 may be any electrode which is capable of providing reference voltage or ground voltage in the display device 100. For example, the second sensing electrode 160 is a battery, a frame, an electrode disposed on the film substrate, a circuit board, or any other conductor having a certain area. The frame could be a middle frame of a cell phone, or a frame of the display panel 130, and the material of the frame may include metal of other suitable conductor. At least part of the second sensing electrode 160 is disposed under the back light module 150. A capacitance is formed between the first sensing electrode 141 and the second sensing electrode 160. When the display device 100 is pressed (e.g. by hands on the cover lens of the display device), the distance between the first sensing electrode 141 and the second sensing electrode 160 is changed at least in part of the overlapped area. It causes capacitance variation between the first sensing electrode 141 and the second sensing electrode 160. Based on the magnitude of the capacitance variation, the first sensing electrode 141 and the second sensing electrode 160 are configured to output a pressure sensing signal representing the magnitude of the external force.

Refer to FIG. 3, in a display device 800, a first sensing electrode 810 is disposed at a side of the substrate 132 far from the substrate 131. For example, the polarizer 135 is disposed between the substrate 132 and the first sensing electrode 810. In some embodiments, the first sensing electrode 810 may be disposed on an independent transparent film substrate (e.g. plastic substrate or polyimide film substrate, or the first sensing electrode 810 may also integrated into a brightness enhancement film or a light diffusion film). The second sensing electrode 820 is, for example, the said battery or the metal frame. Alternatively, the second sensing electrode 820 may be disposed on an independent substrate which is bonded on a frame, in which the substrate may be flexible circuit board or plastic substrate. A capacitor is formed between the first sensing electrode 810 and the second sensing electrode 820 which are configured to output the pressure sensing signal. It's worth mentioning that the first sensing electrode 810 may also be only in the display area or cover part of the display area and part of the non-display area.

FIG. 4 is a cross-sectional view of the display device according to some embodiments. Refer to FIG. 4, in a display device 700, the touch module 110 is the OGS touch module. The touch module 110 includes a glass substrate 701 having a first side 702 and a second side 703 which are opposite to each other. The first side 702 faces the user, and the display panel 130 and the back light module 150 are disposed at the second side 703. The first sensing electrode 710 is disposed at the second side 703 of the glass substrate 701 and is in the non-display area 101. For example, the black matrix 111 in the non-display area 101 is disposed between the glass substrate 701 and the sensing electrode 710. In addition, the second sensing electrode 720 is disposed at a side of the back light module 150 far from the display panel 130. In other words, the second sensing electrode 720 is separated from the first sensing electrode 710 by a predetermined distance. The second sensing electrode 720 is, for example, the said battery or the metal frame. The first sensing electrode 710 and the second sensing electrode 720 are configured to output the pressure sensing signal.

From another aspect, embodiments of the invention provide an electronic device. The electronic device includes the aforementioned display device 1000, 100, 700 or 800. The electronic device could be implemented as smart phone, tablet, industrial computer, laptop, television or other suitable products.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display device with pressure sensing, comprising:
a display panel, comprising a first substrate and a second substrate;
a back light module having a first side and a second side which are opposite to each other wherein the display panel is disposed at the first side of the back light module;
a first sensing electrode, disposed at the first side of the back light module; and
second sensing electrode, wherein at least part of the second sensing electrode is disposed at the second side of the back light module and is separated from the first sensing electrode by a predetermined distance.

2. The display device of claim 1, wherein the second sensing electrode is a battery or a frame.

3. The display device of claim further comprising a touch module, wherein the touch module comprises a glass substrate, and the glass substrate has a first side and a second side which are opposite to each other,
wherein the display panel is disposed between the touch module and the back light module and disposed at the second side of the glass substrate,
wherein the display device has a display area and a non-display area, the first sensing electrode is disposed at the second side of the glass substrate and disposed in the non-display area.

4. The display device of claim 1, wherein the first sensing electrode and the second sensing electrode are configured to detect a force along a normal vector of the display panel, and to output a pressure sensing signal.

5. The display device of claim 2, wherein the second substrate has a first side and a second side which are opposite to each other, the first substrate is disposed at the first side of the second substrate, the back light module is disposed at the second side of the second substrate, and the first sensing electrode is disposed at the second side of the second substrate.

6. The display device of claim 5, further comprising a polarizer which is disposed between the second substrate and the first sensing electrode.

7. The display device of claim 1, further comprising a touch module, and the touch module is an embedded touch module or an out-cell touch module.

8. The display dev of claim 5, wherein the display device has a display area and a non-display area, and the first sensing electrode is disposed in the display area.

9. The display device of claim 1, further comprising touch module, wherein the touch module comprises a touch sensing electrode, and the first substrate has a first side and a second side which are opposite to each other,
wherein the touch sensing electrode is disposed at one of the first side and the second side of the first substrate.

10. The display device of claim 1, further comprising a touch module, wherein the touch module comprises two touch sensing electrodes, and the first substrate has a first side and a second side which are opposite to each other,
wherein the touch sensing electrodes are respectively disposed at the first side and the second side of the first substrate.

11. The display device of claim 1, further comprising a touch module, wherein the touch module comprises two touch sensing electrodes,
wherein the touch sensing electrodes are respectively disposed on the first substrate and on the second substrate.

12. The display device of claim 3, wherein the touch module comprises a black matrix, and the black matrix is disposed between the glass substrate and the first sensing electrode.

13. The display device of claim 1, wherein the first sensing electrode is a patterned sensing electrode.

14. The display device of claim 1, wherein the first sensing electrode is formed of one of indium tin oxide, metal mesh, and nano-meter metal wire.

15. The display device of claim 1, wherein the second sensing electrode is a conductor.

16. An electronic device comprising a display device with pressure sensing, the display device comprising:
a display panel, comprising a first substrate and a second substrate;
a back light module, having a first side and a second side which are opposite to each other, wherein the display panel is disposed at the first side of the back light module;
a first sensing electrode, disposed at the first side of the back light module; and
a second sensing electrode, wherein at least part of the second sensing electrode is disposed at the second side of the back light module and is separated from the first sensing electrode by a predetermined distance.

17. The electronic device of claim 16, wherein the second sensing electrode is a battery or a frame.

18. The electronic device of claim 17, wherein the display device further comprises a touch module, the touch module comprises a glass substrate, and the glass substrate has a first side and a second side which are opposite to each other,
wherein the display panel is disposed between the touch module and the back light module and is disposed at the second side of the glass substrate,
wherein the display device a display area and a non-display area, and the first sensing electrode is disposed at the second side of the glass substrate and in the non-display area.

19. The electronic device of claim 16, wherein the first sensing electrode and the second sensing electrode are configured to detect a force along a normal vector of the display panel, and to output a pressure sensing signal.

20. The electronic device of claim 17, wherein the second substrate has a first side and a second side which are opposite to each other, the first substrate is disposed at the first side of the second substrate, the back light module is disposed at the second side of the second substrate, and the first sensing electrode is disposed at the second side of the second substrate.
